(19) United States
(12) Patent Application Publication
(10) Pub. No.: US 2009/0015618 A1
(43) Pub. Date: Jan. 15, 2009

(54) INKJET IMAGE FORMING APPARATUS AND METHOD TO CONTROL THE SAME

(75) Inventors: Sung June Jung, Suwon-si (KR); Jae Young Chang, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/107,944

(22) Filed: Apr. 23, 2008

(30) Foreign Application Priority Data
Jul. 9, 2007 (KR) 2007-68550

(51) Int. Cl. B41J 29/38

(52) U.S. Cl. 347/17

(57) ABSTRACT

An inkjet image forming apparatus includes a negative pressure controller in an ink supply flow path that connects an ink storage and a print head. The negative pressure controller includes a valve to open and close the flow path to control a negative pressure applied to the print head. If there is a need to cool the ink heated by a maintenance operation performed on the print head or to cool the ink heated by a print job, a controller in the apparatus controls the valve of the negative pressure controller to release the negative pressure applied to the print head so that the print head is filled with low-temperature ink from the ink storage.

### CROSS-REFERENCE TO RELATED APPLICATIONS

This application claims priority under 35 U.S.C. §119(a) from Korean Patent Application No. 2007-0068550, filed on Jul. 9, 2007 in the Korean Intellectual Property Office, the disclosure of which is incorporated herein in its entirety by reference.

### BACKGROUND OF THE INVENTION

1. Field of the Invention

The present general inventive concept relates to an inkjet image forming apparatus and a method to control the same, wherein a negative pressure applied to an inkjet print head is controlled to control a temperature of the print head.

2. Description of the Related Art

Inkjet print heads can be classified into thermally-driven inkjet print heads and piezoelectrically-driven inkjet print heads according to their ink droplet jetting mechanism. The following is the ink droplet jetting mechanism of the thermally-driven inkjet print head. When a pulse current flows through a heater including a resistance heating body, the heater generates heat to instantaneously heat ink in an ink chamber adjacent to the heater to a temperature of about 300° C. Accordingly, the heated ink boils to generate bubbles, which expand to apply a pressure to an interior of the ink chamber that is full of ink. This causes ink adjacent to nozzles to be jetted in the form of droplets through the nozzles out of the ink chamber.

Inkjet image forming apparatuses are classified into a shuttle type which prints an image by moving a print head having a nozzle portion and a line printing type which prints an image by moving a print medium while fixing a print head having a nozzle portion with a same width as that of the print medium.

In order for the inkjet image forming apparatus to print high-quality images, the nozzle portion must be kept in an optimal state, regardless of whether the apparatus is of the shuttle or line printing type. To accomplish this, the inkjet image forming apparatus includes a maintenance device to maintain and keep the nozzle portion in a normal state. The inkjet image forming apparatus generally performs maintenance operations such as spitting, wiping, and capping through the maintenance device.

Before starting a print job, the inkjet image forming apparatus generally performs spitting and wiping as part of a process to prepare for the print job. The inkjet image forming apparatus then heats a substrate to heat ink filled in an ink chamber using a sub-heater provided on the substrate adjacent to the ink chamber.

The substrate heating is to increase the temperature of ink to a level of Ta appropriate for printing by driving the sub-heater until a predetermined time t1 is reached as illustrated in FIG. 1.

The temperature of ink in the inkjet print head is measured by a temperature sensor provided in the print head. The temperature sensor generally uses a thermistor. During a print job, the resistance of the thermistor varies as the temperature of the print head increases. Thus, the temperature of the print head is calculated based on the resistance change of the thermistor.

As illustrated in FIG. 1, the temperature of ink needs to be maintained within a range between a lower temperature limit T1 and an upper temperature limit T2. If the ink temperature is increased to the upper limit T2 at a time t2 during a print job, then a fire pulse is applied to a heater corresponding to the respective nozzles to control the temperature increase. If the ink temperature is reduced to the lower limit T1 at a time t3 due to a long suspension of the print job or other causes, then a warm up pulse is applied to the heater to preheat the ink to prevent the ink temperature from being lowered too much.

If the print job continues for a long time, the ink temperature may be rapidly increased even if the temperature increase is controlled. If the ink temperature reaches a waiting temperature T3 at a time t4, then the print speed is forcibly reduced. If the ink temperature reaches a print suspension temperature T4 at a time t5 even though the print speed has been reduced, then the print job is suspended for purposes of safety.

Substrate heating and spitting is performed as part of the maintenance operation before the print job. In contrast to general maintenance operations, substrate heating is performed after spitting is performed thousands of times in a maintenance operation which is performed to remove foreign substances and bubbles in the ink chamber. The temperature of ink is rapidly raised if substrate heating is performed for several seconds when the ink temperature is already high due to spitting. If a print job starts at the ink temperature raised due to the substrate heating, then the ink temperature is further increased to reach the waiting temperature in a short time. This causes complaints from users since the print speed must be reduced even though a small amount of printing is performed at an initial stage of the print job.

One may consider a method in which the apparatus starts the print job after waiting a certain period of time until the ink temperature becomes low after performing the maintenance operation. However, this method reduces the apparatus's printing performance to respond to a print command from the user since the method increases time required to actually perform printing in response to the print command.

If the ink temperature is increased to the print suspension temperature T4 during a print job, the apparatus must suspend the print job and then wait without any special countermeasure until the ink temperature becomes low. This also causes complaints from users and reduces the reliability of the apparatus.

### SUMMARY OF THE INVENTION

The present general inventive concept provides an inkjet image forming apparatus and a method to control the same, wherein a negative pressure applied to a print head is controlled to control a temperature of the print head.

The present general inventive concept also provides an inkjet image forming apparatus and a method to control the same, wherein ink heated by a maintenance operation to prepare for a print job is removed from a print head and new ink is supplied to the print head to prevent a rapid increase in an ink temperature at an initial stage of the print job so that the print job is reliably performed.

The present general inventive concept also provides an inkjet image forming apparatus and a method to control the same, wherein, if a print job is suspended due to an increase in an ink temperature, then new ink is supplied to the print head to allow the print job to be resumed in a short time.

Additional aspects and/or advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing an inkjet image forming apparatus including an ink storage, a print head to jet ink received from the ink storage to print an image on a print medium, a negative pressure controller connected between the ink storage and the print head to control a negative pressure applied to the print head, and a controller to control an operation of the negative pressure controller to control a temperature of the ink of the print head.

The controller may control the negative pressure controller to release the negative pressure applied to the print head to cool the ink heated by maintenance of the print head.

The controller may start a print job using the print head after releasing the negative pressure applied to the print head.

The controller may determine whether to release the negative pressure applied to the print head based on the number of times of spitting the ink through the nozzles provided on the print head.

When releasing the negative pressure applied to the print head, the negative pressure controller may supply low-temperature ink stored in the ink storage to the print head and discharges the ink in an ink chamber of the print head and then fills the ink chamber with new ink.

The inkjet image forming apparatus may further include a temperature sensor to measure a temperature of the print head, wherein the controller additionally performs an operation to release the negative pressure applied to the print head to cool the ink heated by the maintenance if the print head temperature measured by the temperature sensor is equal to or higher than a reference temperature.

The inkjet image forming apparatus may further include a temperature sensor to measure a temperature of the print head, wherein the controller determines whether to cool the ink heated by a print job based on the temperature measured by the temperature sensor and controls the negative pressure controller to release the negative pressure applied to the controller if a determination is made to cool the heated ink.

The controller may additionally perform an operation to release the negative pressure applied to the print head to cool the ink heated by the print job if the print head temperature measured by the temperature sensor is equal to or higher than a reference temperature.

The controller may resume the print job using the print head if the print head temperature measured by the temperature sensor is reduced below a reference temperature.

The negative pressure controller may include an inlet connected to the ink storage, an outlet connected to the print head, a diaphragm to divide an inner space connecting the inlet and the outlet into inner sections, a push load located in one of the inner sections divided by the diaphragm, a motor to reciprocate the push load under control of the controller, and a valve to open or close the inlet corresponding to an operation of the push load.

The foregoing and/or other aspects and utilities of the present general inventive concept may also be achieved by providing an inkjet image forming apparatus including an ink storage, a print head including a main heater corresponding to a plurality of nozzles provided on a substrate to jet ink received from the ink storage, a sub-heater to heat the substrate, and a temperature sensor, a negative pressure controller having an inlet to receive the ink of the ink storage and an outlet to supply the ink to the print head, the negative pressure controller including a valve provided in a flow path between the inlet and the outlet, a first ink supply flow path connecting the ink storage and the inlet of the negative pressure controller, a second ink supply flow path connecting the print head and the outlet of the negative pressure controller, and a controller to control an operation of the valve of the negative pressure controller to control temperature of the ink of the print head.

The negative pressure controller may further include a motor controlled by the controller and a push load reciprocated by the motor to operate the valve.

The controller may open the valve to discharge the ink filled in an ink chamber of the print head and to supply low-temperature ink in the ink storage to the print head.

The foregoing and/or other aspects and utilities of the present general inventive concept may also be achieved by providing a method to control an inkjet image forming apparatus including an ink storage, a print head to jet ink through a plurality of nozzles to print an image on a print medium, and a negative pressure controller provided in an ink supply flow path connecting the ink storage and the print head to control a negative pressure applied to the print head, the method including performing a maintenance operation on the print head, controlling the negative pressure controller to release the negative pressure applied to the print head after performing the maintenance operation, measuring a temperature of the print head after releasing the negative pressure applied to the print head, and starting a print job using the print head if the temperature of the print head is less than a reference temperature.

The maintenance operation performed on the print head includes spitting that is to jet the ink through the nozzles of the print head and determination of whether to release the negative pressure applied to the print head is made based on a number of times of the spitting.

The negative pressure applied to the print head is additionally released if the temperature of the print head raised by the maintenance operation is not less than the reference temperature.

When releasing the negative pressure applied to the print head, the negative pressure controller provided in the ink supply flow path is controlled to open the ink supply flow path so that ink heated by the spitting in an ink chamber of the print head is discharged and the ink chamber is filled with low-temperature ink of the ink storage.

The foregoing and/or other aspects and utilities of the present general inventive concept may also be achieved by providing a method to control an inkjet image forming apparatus including an ink storage, a print head to jet ink through a plurality of nozzles to print an image on a print medium, and a negative pressure controller provided in an ink supply flow path connecting the ink storage and the print head to control a negative pressure applied to the print head, the method including measuring a temperature of the print head while a print job is performed, suspending the print job and controlling the negative pressure controller to release the negative pressure applied to the print head if the temperature of the print head is equal to or higher than a waiting temperature, measuring a temperature of the print head after releasing the negative pressure applied to the print head, and resuming the print job using the print head if the temperature of the print head is less than a reference temperature.

The negative pressure applied to the print head may additionally released if the temperature of the print head raised by the print job is equal to or higher than the reference temperature.

When releasing the negative pressure applied to the print head, the negative pressure controller provided in the ink supply flow path is controlled to open the ink supply flow path so that the ink heated by the print job in an ink chamber of the print head is discharged and the ink chamber is filled with low-temperature ink of the ink storage.

The foregoing and/or other aspects and utilities of the present general inventive concept may also be achieved by providing a method to control an inkjet image forming apparatus, the method including performing spitting of a print head to jet ink received from an ink storage through nozzles, primarily releasing a negative pressure applied to the print head to release ink heated by the spitting in the print head and to supply new ink from the ink storage to the print head, starting a print job after the primary release of the negative pressure, measuring a temperature of the print head while a print job is performed using the print head, suspending the print job and secondarily releasing a negative pressure applied to the print head to discharge ink in the print head and to supply new ink from the ink storage to the print head if the measured temperature of the print head is equal to or higher than a waiting temperature, and resuming the print job after the secondary release of the negative pressure.

After the primary release of the negative pressure or after the secondary release of the negative pressure, a temperature of the print head may be measured and a negative pressure applied to the print head may be additionally released if the measured temperature of the print head is equal to or higher than a reference temperature.

The foregoing and/or other aspects and utilities of the general inventive concept may also be achieved by providing an inkjet image forming apparatus including a print head having one or more nozzles to eject ink, and a controller to control a removal of heated ink from and a supplying of new ink to the print head to control a temperature of the ink.

The removal of heated ink from and the supplying of new ink to the print head may be based on at least one of a number of times of spitting ink through the one or more nozzles being equal to or greater than a predetermined number and the temperature of the ink being equal to or greater than a predetermined temperature.

The removal of heated ink from and the supplying of new ink to the print head may occur prior to an initial stage of a print job.

The foregoing and/or other aspects and utilities of the general inventive concept may also be achieved by providing an inkjet image forming apparatus including a print head having one or more nozzles to eject ink, and a controller to control a negative pressure to be applied to the print head based on at least one of a number of times of spitting ink through the one or more nozzles being equal to or greater than a predetermined number and the temperature of the ink being equal to or greater than a predetermined temperature

The removal of heated ink from and the supplying of new ink to the print head may occur prior to an initial stage of a print job.

The foregoing and/or other aspects and utilities of the general inventive concept may also be achieved by providing a method of an inkjet image forming apparatus, the method including removing heated ink from a print head, and supplying new ink to the print head according to a character of one of a printing and a maintenance of the print head to control a temperature of the ink.

The foregoing and/or other aspects and utilities of the general inventive concept may also be achieved by providing an inkjet printing method including determining at least one of a number of times of spitting ink through one or more nozzles being equal to or greater than a predetermined number and a temperature of the ink being equal to or greater than a predetermined temperature, and controlling a removal of heated ink from and a supplying of new ink to a print head to control a temperature of the ink based on the determination.

The foregoing and/or other aspects and utilities of the general inventive concept may also be achieved by providing a computer-readable recording medium having embodied thereon a computer program to execute a method, wherein the method includes performing a maintenance operation on a print head, controlling the negative pressure controller to release a negative pressure applied to the print head after performing the maintenance operation, measuring a temperature of the print head after releasing the negative pressure applied to the print head, and starting a print job using the print head if the temperature of the print head is less than a reference temperature.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a graph illustrating changes in a temperature of a conventional print head and processes to be performed as the temperature changes;

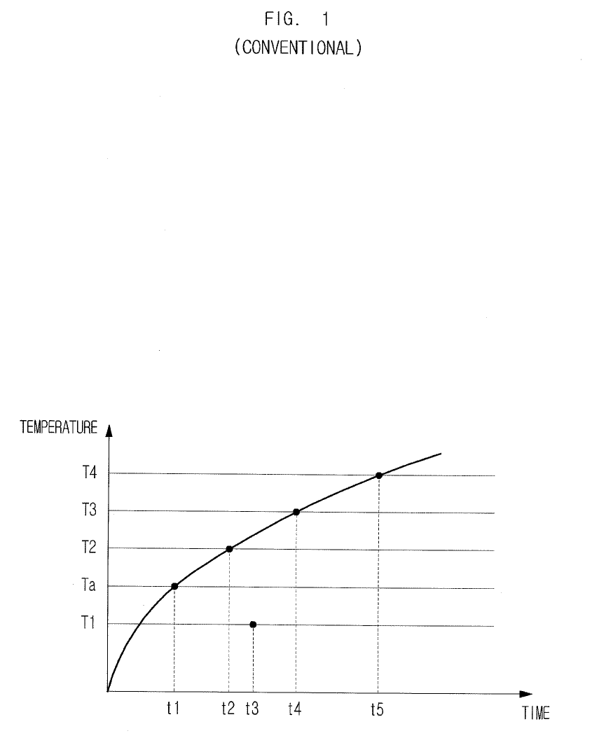

FIG. 2A illustrates a configuration of an inkjet image forming apparatus according to an embodiment of the present general inventive concept;

FIG. 2B illustrates a nozzle portion according to an embodiment of the present general inventive concept;

FIG. 3 is a control block diagram illustrating an inkjet image forming apparatus according to an embodiment of the present general inventive concept;

FIG. 4 illustrates a configuration of a negative pressure controller according to an embodiment of the present general inventive concept;

FIG. 5 is a flow chart illustrating a process to be performed to prepare for a print job in a method to control an inkjet image forming apparatus according to an embodiment of the present general inventive concept; and

FIG. 6 is a flow chart illustrating a process to be performed for a print job in the method to control an inkjet image forming apparatus according to an embodiment of the present general inventive concept.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to the like elements throughout. The embodiments are described below in order to explain the present general inventive concept by referring to the figures.

First, a description will be given of an image forming apparatus and a method to control the same according to an embodiment of the present general inventive concept.

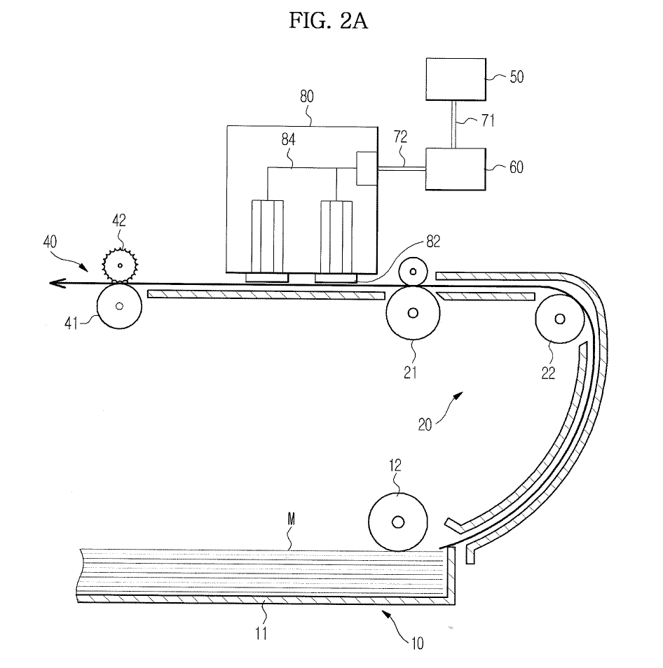

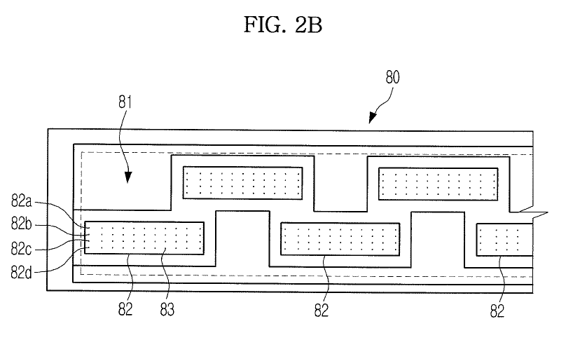

As illustrated in FIG. 2A, the inkjet image forming apparatus according to an embodiment of the present general inventive concept includes a medium feed unit 10 to feed a print medium M, a conveyor unit 20 to convey the print medium M, a print head 80 to form an image on the print medium conveyed by the conveyor unit 20, an ink storage 50 to store ink, a negative pressure controller 60 to control a negative pressure applied to the print head 80, and a medium eject unit 40 to eject the printed print medium out of the inkjet image forming apparatus.

The medium feed unit 10 includes a medium tray 11 in which print media M are stacked and a pickup roller 12 to pick up the print media stacked in the medium tray 11 one by one. The conveyor unit 20 conveys the print medium, picked up by the pickup roller 12, below the print head 80. The conveyor unit 20 may include a feeding roller 21 mounted at an entrance side of the print head 80 and an auxiliary roller 22 mounted between the feeding roller 21 and the pickup roller 12.

In this embodiment, the print head 80 is an array print head including a nozzle portion 81 that has a length corresponding to a width of a print medium. At a fixed position, the print head 80 jets ink to the print medium M to print an image on the print medium.

The print head 80 has a channel unit 84 to guide ink supplied from the ink storage 50 so that the ink is supplied uniformly to the ink chamber of each nozzle 83 (FIG. 2B).

FIG. 2B illustrates the nozzle portion 81 of the print head in the inkjet image forming apparatus of FIG. 2A. As illustrated in FIG. 2B, the nozzle portion 81 includes a plurality of head chips 82 arranged along a width direction of the nozzle portion 81 in a zigzag pattern. Each of the head chips 82 includes a plurality of nozzles 83 formed to jet ink. The head chip 82 may include a plurality of rows of nozzles 82a, 82b, 82c, and 82d. The nozzle rows 82a, 82b, 82c, and 82d may jet ink of a same or different colors (for example, yellow, magenta, cyan, and black). When the print head 80 is constructed so as to jet ink of different colors, the ink storage 50 (FIG. 2A) and the negative pressure controller 60 (FIG. 2A) are individually provided for each of the colors.

Referring to FIG. 2A, the medium eject unit 40 may include an eject roller 41 mounted downstream of the print head 80 in the conveyance direction of the print medium M and a star wheel 42 mounted opposite the eject roller 41. The star wheel 42 prevents the print medium M from contacting the nozzle portion 81 when the print medium M passes below the nozzle portion 81 and prevents changes in the interval between the print medium M and the nozzle portion 81.

The ink storage 50 is connected to the channel unit 84 of the print head 80 through the first and second ink supply flow paths 71 and 72, through which ink is supplied, and the negative pressure controller 60.

The ink storage 50 is mounted at a position higher than the print head 80 to allow ink to be automatically supplied from the ink storage 50 into the print head 80 through the first and second ink supply flow paths 71 and 72 without using any power source.

The print head 80 may be of a thermal type to generate bubbles in ink using a heat source and jets ink droplets by an expansive force of the bubbles. We here omit a detailed description of the thermal type print head since an example of a structure of the thermal type print head is described in U.S. Pat. No. 4,882,595.

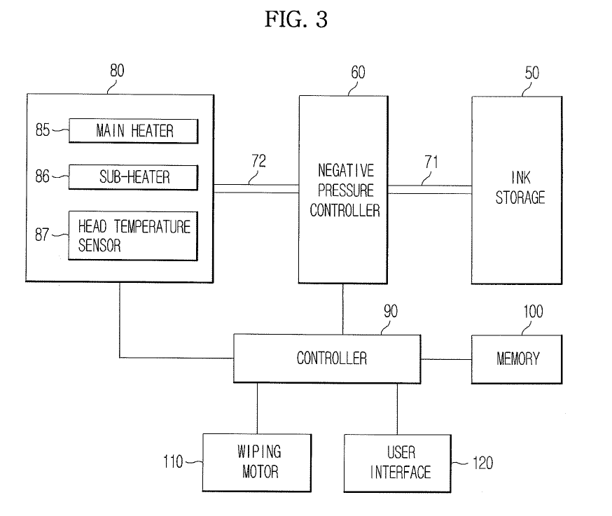

Referring to FIGS. 2 and 3, the print head 80 includes a main heater 85 to heat ink in order to jet ink droplets from the nozzles 83 of the nozzle portion 81, a sub-heater 86 provided on a substrate including the nozzles 83, and a head temperature sensor 87 to measure and provide a temperature of each head chip 82 to a controller 90.

The sub-heater 86 heats the substrate to increase the temperature of ink filled in the ink chamber in the head chip 82. The head temperature sensor 87 changes an electrical resistance thereof according to the temperature of the head chip and applies a corresponding output voltage to the controller 90. The controller 90 controls the sub-heater 86 and the main heater 85 using a fire-pulse current.

A memory 100 stores data to control overall operations of the apparatus including information used to control the negative pressure of the print head and a number of times of spitting to perform a maintenance operation.

A wiping motor 110 drives a wiper under control of the controller 90 to wipe off foreign substances attached to the nozzle portion 81 as part of the maintenance operation. A user interface 120 is used to input commands input by the user, including a print command.

The negative pressure controller 60 is connected to the ink storage 50 through the first ink supply flow path 71 at one side of the negative pressure controller 60 and is connected to the print head 80 through the second ink supply flow path 72 at the other side to supply ink and to control a negative pressure applied the print head 80 under control of the controller 90.

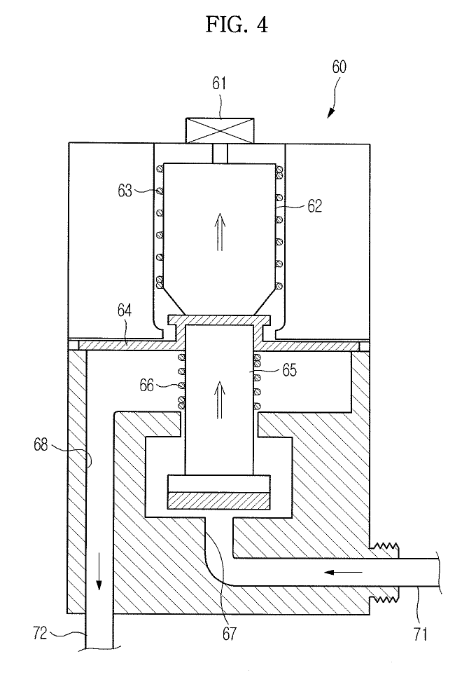

As illustrated in FIG. 4, the negative pressure controller 60 includes a diaphragm 64 to divide an inner space of the negative pressure controller 60 into two inner sections, a push load 62 connected to a motor 61, the push load being located in one of the two inner sections divided by the diaphragm 64, and a valve 65 located in an other inner section to control entrance and exit of ink.

The push load 62 reciprocates as the motor 61 operates under control of the controller 90. One portion of the valve 65 is inserted in a groove formed at the center of the diaphragm 64. An other portion of the valve 65 extends in a longitudinal direction thereof and includes a wide end portion which is located opposite an inlet 67 to open and close the inlet 67 as the push load 62 operates. In a normal mode, the motor 61 is in operation to cause the valve 65 to close the inlet 67.

The first elastic member 63 is disposed on an outer side of the push load 62 to return the push load 62 to an original position. The second elastic member 66 moves the push load 62 up along a direction illustrated by an arrow when the motor 61 is not in operation.

The second elastic member 66 is disposed on an outer side of the valve 65 to return the valve 65 to an original position. The first elastic member 63 moves the valve 65 up along a direction illustrated by an arrow when the motor 61 is not in operation.

When the motor 61 is in operation, one end of the push load 62 moves down to press the diaphragm 64 to cause the valve 65 to move down so that the other portion of the valve 65 closes the inlet 67.

If the inlet 67 is closed, a flow path connecting the first and second ink supply flow paths 71 and 72 is blocked so that the print head 80 is connected to the second ink supply flow path 72 only. Here, a specific negative pressure is applied to the print head 80 since the print head 80 has a form (not illustrated) to apply the specific negative pressure. If a pulse current is applied to the main heater 85 to perform spitting or a print job in this state, ink droplets are jetted through corresponding nozzles and ink is then supplied from the second ink supply flow path 72 to the print head 80 to fill up the print head 80 with ink in a same amount as consumed by the ink jetting operation.

As the amount of ink jetted by the print head 80 increases, the amount of ink in the second ink supply flow path 72 decreases and the negative pressure applied to the print head 80 increases. If the negative pressure applied to the print head 80 exceeds a predetermined level, then the valve 65 is pushed up a pressure difference between the first and second ink supply flow paths 71 and 72 so that the inlet 67 is opened to allow supplementary ink to be supplied to the second ink supply flow path 72.

Alternatively, if spitting is performed as part of the maintenance operation or a print job is performed for a long period of time so that the temperature of ink in the ink chamber becomes excessively high, the controller 90 deactivates the motor 61, so that the negative pressure applied to the print head 80 is released, to remove heated ink from the print head 80 and to fill the print head 80 with new ink. If the motor is deactivated, then the push load 62 moves up to return to an original position and accordingly the valve 65 also moves up to completely open the inlet 67.

The opened inlet 67 is connected to the outlet 68 to form a flow path, thereby releasing the negative pressure applied to the print head 80. This allows ink in the ink storage 50 to be kept supplied to the print head 80 through the first and second ink supply flow paths 71 and 72 so that heated ink in the ink chamber is discharged through the nozzles and new ink at a relatively low temperature is filled into the ink chamber. After ink in the ink storage 50 is supplied to the print head 80 to replace the heated ink in the print head 80 with new ink in this manner, the print head 80 is able to perform a stable printing operation.

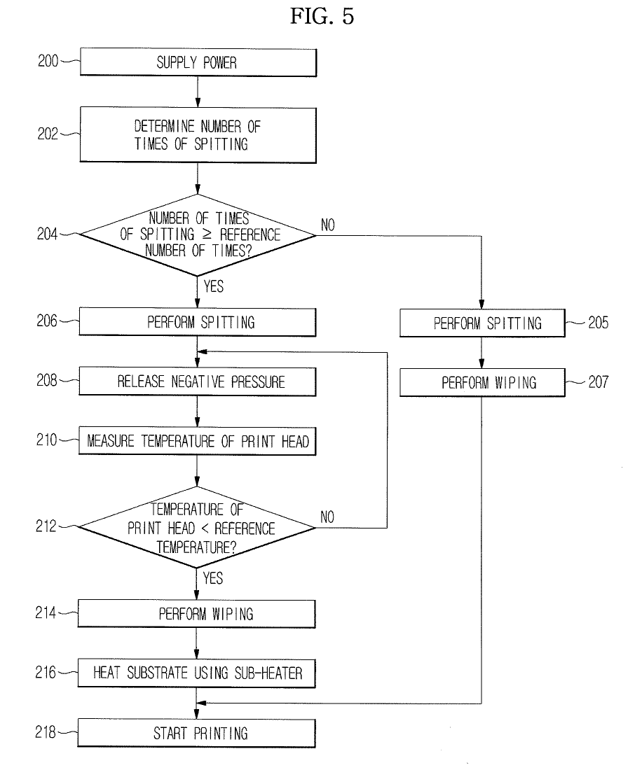

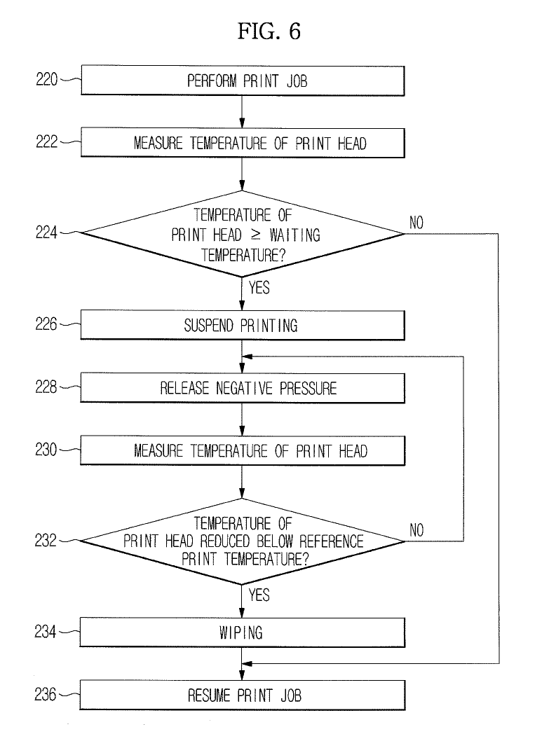

A method to control an inkjet image forming apparatus according to embodiments of the present general inventive concept will now be described with reference to the drawings, mainly FIGS. 5 and 6. FIG. 5 illustrates a process that the apparatus performs when preparing for a print job and FIG. 6 illustrates a process that the apparatus performs when performing a print job.

Referring to FIG. 5, when power is supplied to the apparatus, the apparatus performs maintenance to prepare for a print job (operation 200). Here, the controller 90 determines a number of times spitting is to be performed as part of the maintenance based on a period of time during which the print job has been suspended or based on a number of previously printed dots corresponding to an amount of a previous print job (operation 202). Here, information regarding determination of a number of times of spitting is previously stored in the memory 100.

The controller 90 then determines whether the determined number of times of spitting is equal to or greater than a preset reference number of times (operation 204). If the determined number of times of spitting is less than the preset reference number of times, the controller 90 drives the main heater 85 to perform spitting the determined number of times (operation 205). After finishing the spitting, the controller 90 drives the wiping motor 110 to cause the wiper to clean the nozzles (operation 207). The controller 90 then proceeds to operation 218 to start a print job.

If the number of times of spitting determined in operation 204 is equal to or greater than the preset reference number of times, the controller 90 drives the main heater 85 to perform spitting the determined number of times. Here, as in a normal mode, the controller 90 causes the negative pressure controller 60 to activate the motor 61 to cause the valve 65 to close the inlet 67. This causes a specific negative pressure to be applied to the print head 80 so that a same amount of ink as consumed by the spitting is supplied to the print head 80 (operation 206).

If the spitting is performed the preset number of times, then ink in the ink chamber is heated to increase the ink temperature. Here, the controller 90 deactivates the motor 61 of the negative pressure controller 60 to open the inlet 67 that has been closed by the valve 65. This releases the negative pressure that has been applied to the print head 80. Accordingly, both the first ink supply flow path 71 connected to the opened inlet 67 and the second ink supply flow path 72 connected to the outlet 68 form a flow path so that low-temperature ink stored in the ink storage 50 is supplied to the print head 80, heated ink filled in the ink chamber of the print head 80 is discharged through the nozzles, and the newly supplied low-temperature ink is filled into the ink chamber. When a specific period of time to replace ink has passed, the controller 90 activates the motor 61 to cause the valve 65 to close the inlet 67 as in a normal mode (operation 208).

Then, the head temperature sensor 87 measures and provides a temperature of the print head to the controller 90 (operation 210). The controller 90 then determines whether the temperature of the print head measured by the head temperature sensor 87 is less than a preset reference print temperature (operation 212). The reason for the comparison with the preset reference print temperature is to determine whether to additionally release the negative pressure although low-temperature ink has been primarily supplied to the print head.

If a determination is made in operation 212 that the measured print head temperature is not less than the preset reference print temperature, the controller 90 returns to operation 208 to additionally release the negative pressure.

If a determination is made in operation 212 that the measured print head temperature is less than the preset reference print temperature, the controller 90 determines that the supply of new ink to the print head has reduced the ink temperature to a sufficiently low level and drives the wiping motor 110 to perform wiping to remove foreign substances from the nozzles (operation 214).

The controller 90 then controls the sub-heater 86 to heat the substrate to increase the temperature of ink in the ink chamber to a level appropriate for printing (operation 216). The controller 90 then starts a print job (operation 218).

As illustrated in FIG. 6, in response to a print command the user has input through the user interface 120, the controller 90 controls the main heater 85 to jet ink through the nozzles, thereby performing a print job to print an image on a print medium (operation 220). Here, as in a normal mode, the controller 90 causes the negative pressure controller 60 to activate the motor 61 to allow the valve 65 to close the inlet 67. This causes a specific negative pressure to be applied to the print head 80 so that the same amount of ink as consumed by the spitting is supplied to the print head 80.

During the print job, the head temperature sensor 87 measures and provides a temperature of the print head 80 to the controller 90 (operation 222).

The controller 90 then determines whether the measured print head temperature is equal to or higher than a preset print waiting temperature (operation 224). The reason for the comparison with the preset print waiting temperature is to determine whether to reduce the ink temperature (i.e., to release the negative pressure) because the ink temperature has been raised to a very high level since a large amount of a print job has been performed or printing has been performed for a long period of time.

If a determination is made in operation 224 that the measured print head temperature is less than the preset print waiting temperature, the controller 90 proceeds to operation 236 to resume the print job.

If a determination is made in operation 224 that the measured print head temperature is equal to or higher than the preset print waiting temperature, the controller 90 controls the main heater 85 to suspend the print job which is to print an image on the print medium (operation 226).

The controller 90 then deactivates the motor 61 of the negative pressure controller 60 to open the inlet 67 that has been closed by the valve 65. This releases the negative pressure that has been applied to the print head 80. Accordingly, both the first ink supply flow path 71 connected to the opened inlet 67 and the second ink supply flow path 72 connected to the outlet 68 form a flow path so that low-temperature ink stored in the ink storage 50 is supplied to the print head 80, heated ink filled in the ink chamber of the print head 80 is discharged through the nozzles, and the newly supplied low-temperature ink is filled into the ink chamber. When a specific period of time to replace ink has passed, the controller 90 activates the motor 61 to cause the valve 65 to close the inlet 67 as in a normal mode (operation 228).

Then, the head temperature sensor 87 measures and provides a temperature of the print head to the controller 90 (operation 230).

The controller 90 then determines whether the measured print head temperature has been reduced below a preset reference print temperature (operation 232). If a determination is made in operation 232 that the measured print head temperature has not been reduced below the preset reference print temperature, the controller 90 returns to operation 228 to additionally release the negative pressure.

If a determination is made in operation 232 that the measured print head temperature has been reduced below the preset reference print temperature, the controller 90 determines that the supply of new ink to the print head has reduced the ink temperature to a low level and drives the wiping motor 110 to perform wiping to remove foreign substances from the nozzles (operation 234).

The controller 90 then controls the main heater 85 to resume the print job to print the image on the print medium (operation 236).

The present general inventive concept can also be embodied as computer-readable codes on a computer-readable medium. The computer-readable medium can include a computer-readable recording medium and a computer-readable transmission medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As is apparent from the above description, the present general inventive concept provides an inkjet image forming apparatus and a method to control the same with a variety of features and advantages. For example, when a temperature of ink has become excessively high due to spitting which is part of a maintenance operation to prepare for a print job, a negative pressure applied to a print head is released to remove heated ink from the print head and to supply low-temperature ink to the print head, thereby preventing a rapid increase in the temperature of the ink at an initial stage of the print job.

In addition, when a temperature of ink has been raised due to a print job, a negative pressure applied to a print head is released to remove heated ink from the print head and to supply low-temperature ink to the print head to cool the print head, whereby the print job can be resumed in a short period of time.

Although various embodiments of the present general inventive concept have been illustrated and described, it would be appreciated by those skilled in the art that changes may be made in these embodiments without departing from the principles and spirit of the general inventive concept, the scope of which is defined in the appended claims and their equivalents.

What is claimed is:

1. An inkjet image forming apparatus, comprising:
an ink storage;
a print head to jet ink received from the ink storage to print an image on a print medium;
a negative pressure controller connected between the ink storage and the print head to control a negative pressure applied to the print head; and
a controller to control an operation of the negative pressure controller to control temperature of the ink of the print head.

2. The inkjet image forming apparatus according to claim 1, wherein the controller controls the negative pressure controller to release the negative pressure applied to the print head to cool the ink heated by maintenance of the print head.

3. The inkjet image forming apparatus according to claim 2, wherein the controller starts a print job using the print head after releasing the negative pressure applied to the print head.

4. The inkjet image forming apparatus according to claim 2, wherein the controller determines whether to release the negative pressure applied to the print head based on a number of times of spitting the ink through the nozzles provided on the print head.

5. The inkjet image forming apparatus according to claim 2, wherein, when releasing the negative pressure applied to the print head, the negative pressure controller supplies low-temperature ink stored in the ink storage to the print head and discharges the ink in an ink chamber of the print head and then fills the ink chamber with new ink.

6. The inkjet image forming apparatus according to claim 2, further comprising:
a temperature sensor to measure a temperature of the print head,
wherein the controller additionally performs an operation to release the negative pressure applied to the print head to cool the ink heated by the maintenance if the print head temperature measured by the temperature sensor is equal to or higher than a reference temperature.

7. The inkjet image forming apparatus according to claim 1, further comprising:
a temperature sensor to measure a temperature of the print head,
wherein the controller determines whether to cool ink heated by a print job based on the temperature measured by the temperature sensor and controls the negative pressure controller to release the negative pressure applied to the controller if a determination is made to cool the heated ink.

8. The inkjet image forming apparatus according to claim 7, wherein the controller additionally performs an operation to release the negative pressure applied to the print head to cool the ink heated by the print job if the print head temperature measured by the temperature sensor is equal to or higher than a reference temperature.

9. The inkjet image forming apparatus according to claim 7, wherein the controller resumes the print job using the print head if the print head temperature measured by the temperature sensor is reduced below a reference temperature.

10. The inkjet image forming apparatus according to claim 1, wherein the negative pressure controller comprises:
an inlet connected to the ink storage;
an outlet connected to the print head;
a diaphragm to divide an inner space connecting the inlet and the outlet into inner sections;
a push load located in one of the inner sections divided by the diaphragm;
a motor to reciprocate the push load under control of the controller; and
a valve to open or close the inlet corresponding to an operation of the push load.

11. An inkjet image forming apparatus, comprising:
an ink storage;
a print head including a main heater corresponding to a plurality of nozzles provided on a substrate to jet ink received from the ink storage, a sub-heater to heat the substrate, and a temperature sensor;
a negative pressure controller having an inlet to receive the ink of the ink storage and an outlet to supply the ink to the print head, the negative pressure controller including a valve provided in a flow path between the inlet and the outlet;
a first ink supply flow path connecting the ink storage and the inlet of the negative pressure controller;
a second ink supply flow path connecting the print head and the outlet of the negative pressure controller; and
a controller to control an operation of the valve of the negative pressure controller to control temperature of the ink of the print head.

12. The inkjet image forming apparatus according to claim 11, wherein the negative pressure controller further comprises:
a motor controlled by the controller; and
a push load reciprocated by the motor to operate the valve.

13. The inkjet image forming apparatus according to claim 11, wherein the controller opens the valve to discharge the ink filled in an ink chamber of the print head and to supply low-temperature ink in the ink storage to the print head.

14. A method to control an inkjet image forming apparatus including an ink storage, a print head to jet ink through a plurality of nozzles to print an image on a print medium, and a negative pressure controller provided in an ink supply flow path connecting the ink storage and the print head to control a negative pressure applied to the print head, the method comprising:
performing a maintenance operation on the print head;
controlling the negative pressure controller to release the negative pressure applied to the print head after performing the maintenance operation;
measuring a temperature of the print head after releasing the negative pressure applied to the print head; and
starting a print job using the print head if the temperature of the print head is less than a reference temperature.

15. The method according to claim 14, wherein the maintenance operation performed on the print head includes spitting ink through the nozzles of the print head and determination of whether to release the negative pressure applied to the print head is made based on a number of times of the spitting.

16. The method according to claim 15, wherein the negative pressure applied to the print head is additionally released if the temperature of the print head raised by the maintenance operation is not less than the reference temperature.

17. The method according to claim 15, wherein, when releasing the negative pressure applied to the print head, the negative pressure controller provided in the ink supply flow path is controlled to open the ink supply flow path so that ink heated by the spitting in an ink chamber of the print head is discharged and the ink chamber is filled with low-temperature ink of the ink storage.

18. A method to control an inkjet image forming apparatus including an ink storage, a print head to jet ink through a plurality of nozzles to print an image on a print medium, and a negative pressure controller provided in an ink supply flow path connecting the ink storage and the print head to control a negative pressure applied to the print head, the method comprising:
measuring a temperature of the print head while a print job is performed;
suspending the print job and controlling the negative pressure controller to release the negative pressure applied to the print head if the temperature of the print head is equal to or higher than a waiting temperature;
measuring a temperature of the print head after releasing the negative pressure applied to the print head; and
resuming the print job using the print head if the temperature of the print head is less than a reference temperature.

19. The method according to claim 18, wherein the negative pressure applied to the print head is additionally released if the temperature of the print head raised by the print job is equal to or higher than the reference temperature.

20. The method according to claim 18, wherein, when releasing the negative pressure applied to the print head, the negative pressure controller provided in the ink supply flow path is controlled to open the ink supply flow path so that the ink heated by the print job in an ink chamber of the print head is discharged and the ink chamber is filled with low-temperature ink of the ink storage.

21. A method to control an inkjet image forming apparatus, the method comprising:
performing spitting of a print head to jet ink received from an ink storage through nozzles;
primarily releasing a negative pressure applied to the print head to release the ink heated by the spitting in the print head and to supply new ink from the ink storage to the print head;
starting a print job after the primary release of the negative pressure;
measuring a temperature of the print head while a print job is performed using the print head;
suspending the print job and secondarily releasing a negative pressure applied to the print head to discharge ink in the print head and to supply new ink from the ink storage to the print head if the measured temperature of the print head is equal to or higher than a waiting temperature; and
resuming the print job after the secondary release of the negative pressure.

22. The method according to claim 21, wherein, after the primary release of the negative pressure or after the secondary release of the negative pressure, a temperature of the print head is measured and a negative pressure applied to the print head is additionally released if the measured temperature of the print head is equal to or higher than a reference temperature.

23. An inkjet printing method, comprising:
determining at least one of a number of times of spitting ink through one or more nozzles being equal to or greater than a predetermined number and a temperature of the ink being equal to or greater than a predetermined temperature; and
controlling a removal of heated ink from and a supplying of new ink to a print head to control a temperature of the ink based on the determination.
